(19) United States
(12) Patent Application Publication
(10) Pub. No.: US 2009/0101709 A1
(43) Pub. Date: Apr. 23, 2009

(54) ENTRANCE CONTROL SYSTEM AND ENTRANCE CONTROL DEVICE

(75) Inventor: Nobuyuki Nonaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Aruze Corp., Tokyo (JP); Seta Corp., Tokyo (JP)

(21) Appl. No.: 12/297,648

(22) PCT Filed: Apr. 20, 2007
(86) PCT No.: PCT/JP2007/058649

§ 371 Date: Oct. 20, 2008

(30) Foreign Application Priority Data
May 26, 2006 (JP) 2006-146550

(51) Int. Cl. G06K 5/00

(52) U.S. Cl. 235/382

(57) ABSTRACT

An access control system and device is provided which is capable of preventing, if the system operates, and then, a door, etc., is opened, the entry of a third party due to abuse of an opportunity of the opening. An access control system (1) includes: a reader/writer (30) for reading the identification information and measuring a signal state at a time of reading the identification information; an imaging device (50) for imaging periphery of the pass point; and an access control device (10), which judges whether or not an access is possible, based upon outputs of the reader/writer (30) and the imaging device (50). The access control device (10) judges whether or not the person has an access right about the wireless IC tag (20) on the basis of the unique ID, computes the position and movement state of the wireless tag holder (201) from the signal state established at the time of reading the unique ID, judges whether or not there is any wireless IC tag non-holder (202) from the image data output from the imaging device (50), and judges whether or not the pass point is placed in a pass permission state according to whether or not the person has a right to access the room, the position and movement state of the wireless IC tag holder (201), and whether or not there is any wireless IC tag non-holder (202).

### TECHNICAL FIELD

The present invention relates to an access control system and device, and more particularly, to an access control system and device utilizing an identification information storage medium which is readable by radio equipment such as a wireless IC tag.

### BACKGROUND ART

In recent years, there has been a growing interest in how to ensure security in various locations such as companies or households or multifamily dwellings such as condominiums. This is because critical feeling about crimes due to entry of suspicious person(s) or information leak, etc. is growing high. As a security-related technique of inhibiting and limiting such entry of suspicious person(s), an access control system utilizing a so called IC card is proposed. For example, there is proposed an access control system (Japanese Patent Application Laid-open No. 5-314138, for example) of making judgment of unlocking by means of a card (for example, an IC card) with a high falsification difficulty, for example, in a room or the like with a high security rank given; and making judgment of unlocking by means of a card (for example, a magnetic stripe card) with a low falsification difficulty, for example, in a room or the like with a low security rank given (Japanese Patent Application Laid-open No. 5-314138, for example).

However, having a card holder such as an employee own plural kinds of cards for the sake of access control may cause the cards to become bulky and may cause the card holder to feel inconvenience in portability. Further, there is a need to select a corresponding card in accordance with a security rank, and therefore, it may take long to use the card, and a speedy access may be precluded.

Further, if a third party has illegally acquired a card, and the actual card owner is not aware of a loss or theft of the card, it is difficult to prevent such illegal access of a third party. Even if the third party illegally enters a room, facial data of the third party is not evidently left, and thus, an illegal user cannot be specified.

Furthermore, when a person having a legal access right enters a room, an illegal third party might also enter the room through an opened door.

### DISCLOSURE OF THE INVENTION

An object of the present invention is to prevent, if an access control system operates, and then, a door or the like is opened, the entry of a third party due to abuse of an opportunity of the opening.

As means for solving the above-described problems, the present invention has the following features.

A first aspect of the present invention is proposed as an access control system of reading identification information from an identification information storage medium (a wireless IC tag, for example) storing identification information (a unique ID, for example) which is wirelessly readable, and then, controlling an access passing through a pass point, based upon the read identification information.

This access control system is characterized by comprising: a reading portion for reading the identification information and measuring a signal state at a time of reading the identification information; an imaging portion for imaging periphery of the pass point; and an access control device, which judges whether or not an access is possible, based upon outputs of the reading portion and imaging portion, wherein the access control device judges the presence or absence of an access right relevant to the identification information storage medium, based upon the identification information, and then, computes a position and a movement state of the identification information storage medium from the signal state at the time of reading the identification information; judges presence or absence of a target other than that which owns the identification information storage medium, from image data output by the imaging portion; and judges whether or not the pass point is placed in a pass permission state, based upon presence or absence of the access right, the position and movement state of the identification information storage medium, and the presence or absence of said other target.

According to this system, even if one having the wireless IC tag having the access right (a wireless IC tag holder) approaches the pass point, if the suspicious third party exists near the pass point or the one having the wireless IC tag merely passes through the vicinity of the pass point, the pass point is never placed in a pass permission state. Thus, it is possible to prevent the entry of an unauthorized third party due to abuse of an opportunity of the wireless IC tag holder, or alternatively, it is possible to prevent entry or getting lost on one's way of the unauthorized third party by establishing a pass permission state if the vicinity of the pass point is passed.

In the abovementioned system, the access control device may judge the position and movement state of another target from image data which the imaging portion outputs so as to judge whether or not the pass point is placed in the pass permission state, based upon the position and movement state of such another target.

According to such system, it is judged whether or not the pass point is placed in the pass permission state in consideration of the position and movement state of another target, and thus, if there is no apprehension that another target attempts to make illegal entry, it is possible to speedily permit the passing of the wireless IC tag holder, and therefore, it is possible to achieve access control such that the user never suffers from a stress.

In the abovementioned system, the passing on the pass point is managed instead of the access passing the pass point, and the access control device judges the presence or absence of a pass right relevant to the identification information storage medium, based upon the identification information so as to judge whether or not the pass point is placed in the pass permission state.

According to this system, it is possible to attain advantageous effect similar to that in a case where one having the wireless IC tag having the access right (the wireless IC tag holder) approaches the pass point even if one having the pass right (the wireless IC tag holder) approaches the pass point.

A second aspect of the present invention is proposed as an access control device.

This access control device is characterized by comprising: a right judging portion (a right judging section 102, for example) for judging the presence or absence of an access passing through a pass point, based upon identification information read from an identification storage medium; a movement analyzing portion (a movement analyzing section 103, for example) for computing a distance from the identification information storage medium, based upon a signal state (including all information which can be measured based upon a signal from an identification information storage medium, such as electric field intensity, the number of successes of reading, radio wave distribution, radio wave propagation, and a success rate of reading at a time of reading the identification information), and then, computing a position and a movement state of the identification information storage medium, based upon the computed distance; and an image analyzing portion (image analyzing section 101, for example) for analyzing image data obtained by imaging periphery of the pass point, thereby sampling a target existing in an imaging range which is an area of the periphery of the pass point and computing a position and a movement state of a target which does not correspond to the identification information storage medium, from among the sampled targets, wherein it is judged whether or not the pass point is placed in a pass permission state, based upon the presence or absence of a right of the access, the position and movement state of the identification information storage medium, and the position and movement state of the target which does not correspond to the identification information storage medium. According to such access control device, even if one having the wireless IC tag having the access right (the wireless IC tag holder) merely approaches the pass point, if the suspicious third party exists near the pass point or the one having the wireless IC tag merely passes through the vicinity of the pass point, the pass point is never placed in a pass permission state. Thus, it is possible to prevent the entry of an unauthorized third party due to abuse of an opportunity of the wireless IC tag holder, or alternatively, it is possible to prevent entry or loss on one's way of the unauthorized third party by establishing a pass permission state if the vicinity of the pass point is passed.

In the abovementioned access control device, the right judging portion judges the presence or absence of the passing on the pass point instead of the access passing the pass point, based upon the identification information so as to judge whether or not the pass point is placed in the pass permission state.

According to this access control device, it is possible to attain advantageous effect similar to that in a case where one having the wireless IC tag having the access right (the wireless IC tag holder) approaches the pass point even if one having the pass right (the wireless IC tag holder) approaches the pass point.

### BRIEF DESCRIPTION OF THE DRAWINGS

FIG. 1 is a conceptual view of an access control system according to an embodiment of the present invention;

FIG. 2 is a block diagram of the access control system according to the embodiment;

FIG. 3 is a view showing an example in which the access control system according to the embodiment judges that a pass permission state may be established;

FIG. 4 is a view showing an example in which the access control system according to the embodiment judges that a pass permission state may not be established;

FIG. 5 is a view showing an example in which the access control system according to the embodiment judges that a pass permission state may be established;

FIG. 6 is a view showing an example in which the access control system according to the embodiment judges that a pass permission state may not be established;

FIG. 7 is a view showing an example in which the access control system according to the embodiment judges that a pass permission state may not be established;

FIG. 8 is a view showing an example in which the access control system according to the embodiment judges that a pass permission state may not be established;

FIG. 9 is a view showing an example of reading result data stored by a movement analyzing section of the access control system according to the embodiment;

FIG. 10 is a view showing an example of data used for the movement analyzing section of the access control system according to the embodiment to compute an estimated distance from the number of successes;

FIG. 11 is a view showing an exemplary table storing a result obtained when the movement analyzing section of the access control system according to the embodiment computes an estimated position of a wireless IC tag, based upon the estimated distance computed from the number of successes; and

FIG. 12 is a conceptual view of a method of, the movement analyzing section of the access control system according to the embodiment, computing an estimated position, based upon estimated distances stored in first and second estimated-distance fields.

### BEST MODE FOR CARRYING OUT THE INVENTION

Hereinafter, embodiments of the present invention will be described with referring to the drawings.

### First Embodiment

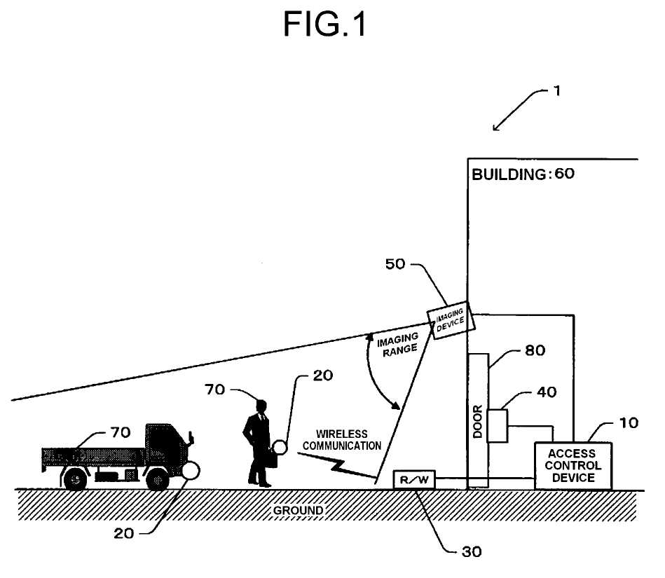

FIG. 1 is a view showing an overview of an access control system according to a first embodiment of the present invention.

This access control system 1 is a system which achieves security of a control target area by enabling authorized entities (such as persons or vehicles) to enter/exit or pass through the control target area and by disabling suspicious entities to enter/exit or pass through the area. Any control target area may be available as long as it has a predetermined space, and includes a building, a room, a facility, a land, or a vehicle (an aircraft, a ship, or a train), for example.

This access control system 1 has: an access control device 10; a reader/writer 30 for reading a wireless IC tag 20; a pass controller 40 (such as an electronic key or a door opening/closing device, for example) for enabling or disabling the passing of mobile entities such as persons or vehicles at a pass point such as a door, a gateway, a gate, an entrance; and an imaging device 50 (such as a CCD camera, for example) for imaging an area around the pass controller 40.

A visitor 70, such as a person or a vehicle, visits a building 60 provided as an exemplary control target area. An access control device 10 judges a right for the visitor 70 to enter/exit the building 60 as a control target area, i.e., whether or not the visitor 70 has a right to pass through a door 80 as a pass point, by reading the wireless IC tag 20 owned and carried by the visitor 70 by means of the reader/writer 30. In other words, the access control device 10 stores a unique ID and access right, which the wireless IC tag 20 stores, in association with each other, and is capable of checking the access right of the visitor 70, who owns and carries the wireless IC tag 20, based upon the unique ID read from the wireless IC tag 20.

Upon judging that the visitor 70 has an access right about the pass point, the access control device 10 changes the pass point to a pass permission state (for example, by unlocking an electronic key provided at a door or driving the door by means of a driving motor or the like, thereby establishing an open state). Then, the visitor passes through the door 80 changed to the pass permission state, enters the building 60, does business, makes arrangements beforehand, and takes in and out baggage. The visitor, having finished one's business, causes the access control device 10 to open the door 80, based upon a reading result of the wireless IC tag, in a similar manner as that at the time of entry, and leaves the building 60. The access control device 10 speedily changes the door 80 to a pass non-permission state (for example, by locking an electronic key provided at the door or driving the door by means of a driving motor or the like, thereby establishing a closed state) so as to prevent the entry of suspicious persons through the opened door 80.

Further, this access control system 1 computes positional information of the visitor 70 by measuring the position of the wireless IC tag 20 or a distance from the wireless IC tag 20, based upon intensity of a radio-wave or electric field (hereinafter, simply referred to as electric field intensity), which the reader/writer 30 has received from the wireless IC tag 20. This system measures a movement state (such as a movement direction or a movement speed) of a visitor from a variation with the elapse of time of this positional information, controls the pass controller 40, and is utilized for judgment of the change of a pass permission state/a pass non-permission state of a pass point.

The access control system 1 serves to image the periphery of the pass point by means of an imaging device 50, and then, analyze image data generated by means of such imaging, thereby detecting the presence of suspicious entities that do not have the wireless IC tag 20 (including both of persons and vehicles) and its movement state. Further, this system is also utilized for the sake of judgment of change of the open/close state of the pass controller 40.

[Exemplary Configuration of the Access Control System]

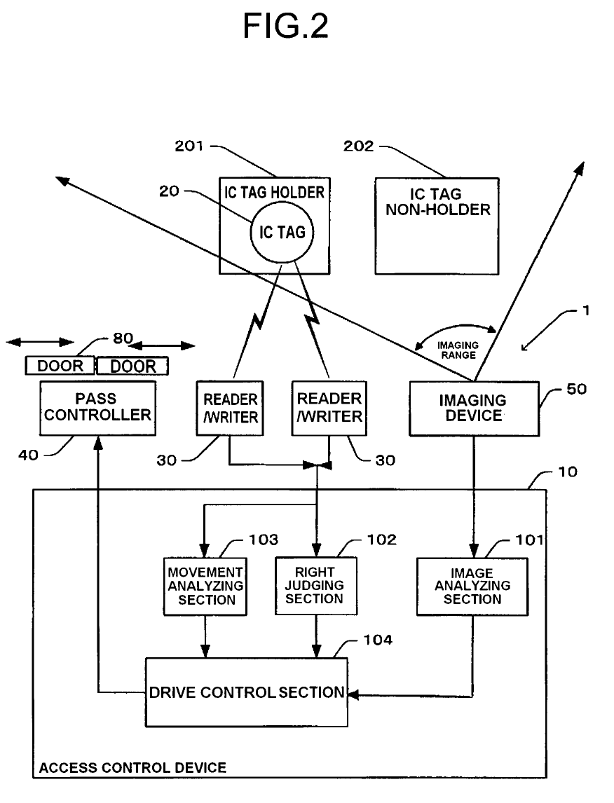

Next, an exemplary configuration of the access control system 1 will be described with referring to FIG. 2. The figure is a block diagram depicting an exemplary configuration of this access control system 1.

The access control system 1 has: an access control device 10; a pass controller 40 connected to the access control device 10; a reader/writer 30 connected to the access control device, similarly; and an imaging device 50 connected to the access control device, similarly.

[Access Control Device]

The access control device 10 is a device, which drives the pass controller 40, based upon outputs from the reader/writer 30 and the imaging device 50, and which changes a pass permission state/a pass non-permission state therebetween at a pass point.

The access control device 10 is provided with: a processor (CPU); a main memory (RAM); a read-only memory (ROM); an input/output device (I/O); and an external storage device such as a hard disk drive unit if necessary, and is an information processing device such as a computer or a workstation. The aforementioned ROM or hard disk drive unit stores: a program for causing the information processing device to function as the access control device 10; or a program, which causes the information processing device to execute an access control method. This program is downloaded on a main memory, and then, is executed by the CPU, whereby the access control device 10 or the access control method is implemented. Further, the abovementioned programs need not always be stored in a storage device in the information processing device, and may be provided from an external device (such as server of ASP (Application Service Processor), for example), and thereafter, downloaded on the main memory.

The access control device 10 has: an image analyzing section 101 connected to the imaging device 50; a right judging section 102 connected to the reader/writer 30; a movement analyzing section 103 connected to the reader/writer 30 similarly; and a drive control section 104, which receives the outputs from the image analyzing section 101, the right judging section 102, and the movement analyzing section 103, and then, based upon these outputs, drives the pass controller 40 and judges whether or not to change a pass permission state/a pass non-permission state at a pass point.

The image analyzing section 101 acquires image data from the imaging device 50; performs an image analyzing process for image data; and samples a target existing in an imaging range which is an area near the pass controller 40, i.e., around the pass point. For example, the image analyzing section 101 samples targets by utilizing a background differentiation technique, an inter-frame differentiation technique, and an optical flow, from movement image data output from the imaging device 50, and then, outputs features of movements of targets included in the image. In other words, the image analyzing section 101 determines what kind of target exists from the acquired image and how each of the targets moves, and then, outputs an image analysis result.

The right judging section 102 compares a unique ID of the wireless IC tag 20 read by the reader/writer 30 with a previously-stored access right table; verify whether or not to meet a condition that the unique ID is included in the access right table and the access right assigned to that unique ID is permitted to pass through a pass point; and outputs a right check result.

The movement analyzing section 103 computes a distance between the wireless IC tag 20 and the reader/writer 30, based upon electric field intensity from the wireless IC tag 20 detected by the reader/writer 30, and then, computes the position of the wireless IC tag 20, based upon the computed distance. By storing this position hourly with the elapse of time, the position and movement state (such as a trajectory or a vector) of the wireless IC tag 20, i.e., the visitor 70, are output as a movement analysis result. As a method of computing the position of the wireless IC tag 20, based upon the electric field intensity, it is thought to employ the method, etc., disclosed in Japanese Patent Application Laid-open No. 2002-159041, for example.

The drive control section 104 receives the outputs of the image analyzing section 101, the right judging section 102, and the movement analyzing section 103; based upon these outputs, drives the pass controller 40; and judges whether or not to change the pass permission state/pass non-permission state at a pass point (for example, changing the unlocked state/locked state). In other words, this pass controller 40 is driven to change a pass point from the pass non-permission state to the pass permission state only in the case of meeting conditions that: (1) the right check result from the right judging section 102 indicates that the pass permission state may be established; (2) the movement analysis result from the movement analyzing section 103 indicates that the pass permission state may be established; and (3) the image analysis result from the image analyzing section 101 indicates that the pass permission state may be established.

A case in which the right check result indicates that the pass permission state may be established is equivalent to a case in which the unique ID read from the wireless IC tag 20 has an access right.

A case in which the movement analysis result from the movement analyzing section 103 indicates that the pass permission state may be established is equivalent to a case in which the movement state of the wireless IC tag holder 201, who holds and carries the wireless IC tag 20, is suitable for changing the pass point to the pass permission state, for example, a case in which it is possible to judge that the holder 201 forwards toward the pass point.

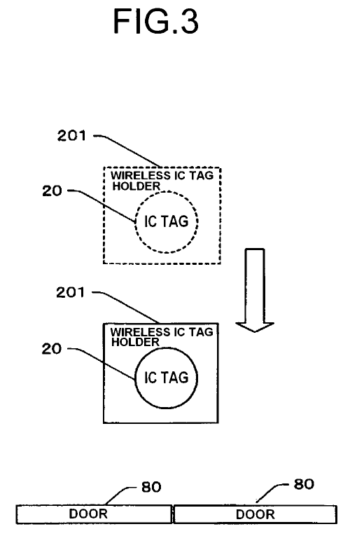

FIG. 3 is a view showing an exemplary case in which the movement analysis result from the movement analyzing section 103 indicates that the pass permission state may be established. In FIG. 3, it is presupposed that the wireless IC tag holder 201 forwards toward the door 80 that is a pass point. Such movement state is kept track of by means of position measurement due to the electric field intensity read by the reader/writer 30. The drive control section 104 having received such movement analysis result judges a case in which the movement analysis result from the movement analyzing section 103 indicates that the pass permission state may be established.

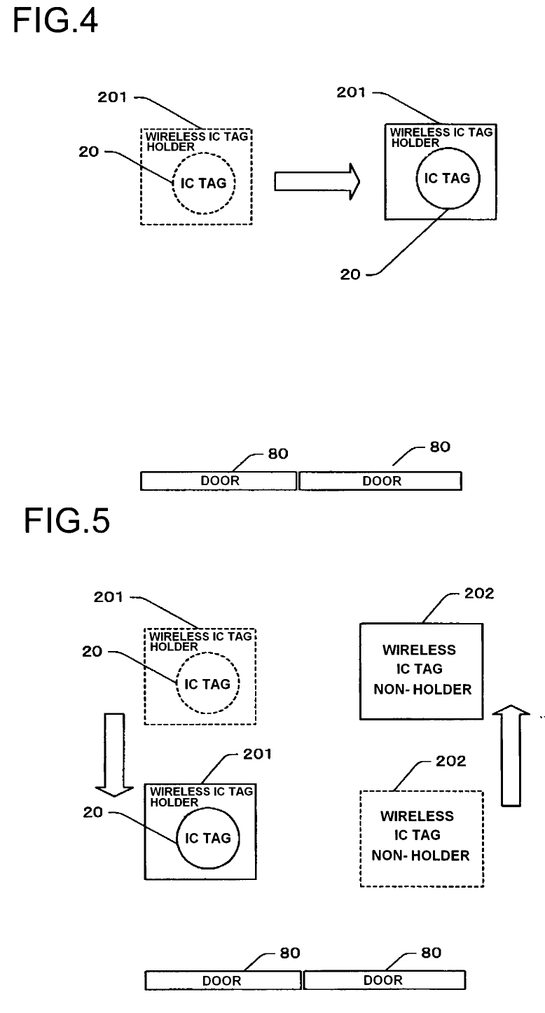

FIG. 4 is a view showing an exemplary case in which the movement analysis result from the movement analyzing section 103 indicates that the pass permission state may not be established. In the example of FIG. 4, it is presupposed that the wireless IC tag holder 201 is moving to cross the front of the door 80 that is a pass point. Such movement state of the wireless IC tag holder 201 can be estimated as a movement state in which the holder is moving to another destination without intending to pass through the pass point. In such a case, if the pass point is placed in the pass permission state, an unexpected entry of a third party may be allowed. The drive control section 104, having thus received such movement analysis result, judges that the movement analysis result from the movement analyzing section 103 indicates that the pass permission state may not be established.

Next, the image analysis result from the image analyzing section 101 will be described.

A case in which the image analysis result from the image analyzing section 101 indicates that the pass permission state may be established is equivalent to a case in which no target other than the wireless IC tag holder 201, who owns and carries the wireless IC tag 20, exists within the imaging range, i.e., around the door 80 that is a pass point, or alternatively, a case in which, even if a target other than the wireless IC tag holder 201 exists, the movement state does not imply the danger of pass point entry.

FIG. 5 is a view showing an exemplary case in which the image analysis result indicates that the pass permission state may be established. In the example shown in FIG. 5, the wireless IC tag holder 201 is moving to forward toward the door 80 that is a pass point. As the result of image analysis, further, it is judged that a wireless IC tag non-holder 202, who is a person failing to have the wireless IC tag 20, exists in the imaging range of the imaging device 50, and the movement state is a state in which the non-holder is moving to a site distant from the door 80 that is a pass point.

In such case, while the wireless IC tag non-holder 202 exists, the non-holder is moving to a site distant from the pass point, so that, even if the pass point is placed in a pass permission state, there is no apprehension that an unexpected entry is allowed. Thus, the drive control section 104 judges that the image analysis result indicates that the pass permission state may be established, if the image analysis result of such content is received from the image analyzing section 101. In respect of whether the target sampled as the result of image analysis is the wireless IC tag holder 201 or the wireless IC tag non-holder 202, which one of the targets is the wireless IC tag holder 201 or which one of the target is the wireless IC tag non-holder 202 is determined by comparing and crosschecking positional information of the targets due to image analysis.

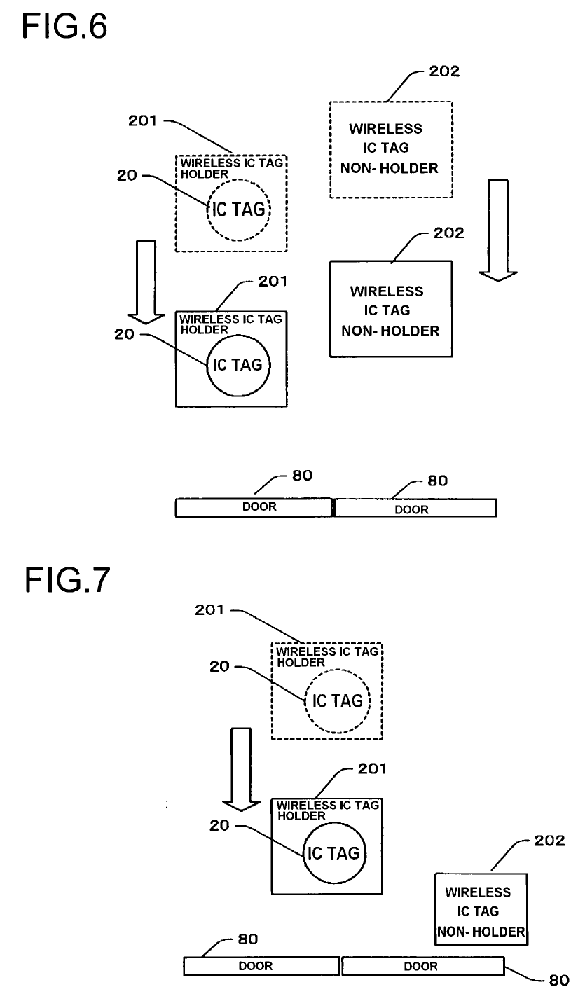

FIG. 6 shows a case in which the wireless IC tag holder 201 is moving to forward toward the door that is a pass point and the wireless IC tag non-holder 202 is moving toward the door 80 that is a pass point. In such case, because the wireless IC tag non-holder 202 exists and its movement state is a movement state in which a pass point is passed, the drive control section 104 judges that the image analysis result from the image analyzing section 101 fails to indicate that the pass permission state may be established, upon the receipt of the image analysis result corresponding to that obtained in FIG. 6.

FIG. 7 shows a case in which the wireless IC tag holder 201 is moving toward the door 80 that is a pass point and the wireless IC tag non-holder 202 does not move (shift) and stays near the pass point. In such case, if the pass point is placed in a pass permission state for the wireless IC tag holder 201, the wireless IC tag non-holder 202 may attempt to pass through the pass point due to abuse of such opportunity. Thus, the drive control section 104 judges that the image analysis result from the image analyzing section 101 fails to indicate that the pass permission state may be established.

Turning to FIG. 2, a description of an exemplary configuration of the access control system 1 is continued.

The imaging device 50 is a device which images a pass point or its periphery and which generates and outputs image data. This imaging device is also a digital video camera or a CCD camera, etc.

The reader/writer 30 is a device which is capable of wirelessly reading a unique ID that is identification information stored by the wireless IC tag 20. In the present invention, it is sufficient if the reader/writer 30 has a read function, and does not always need to have a write function, and, even a device failing to have a writing function corresponds to the reader/writer 30 according to the present invention. Further, the reader/writer in the present invention needs to have a function of measuring intensity (radio wave intensity, electric field intensity) of a signal received from the wireless IC tag 20, and then, outputting the measured intensity as information.

The pass controller 40 is a device which executes a mechanical operation for changing the pass permission state and the pass non-permission state of a pass point, and is an electronic key or any of the mechanical door, gate, shutter, and door, driven by means of a driving motor, for example. The pass controller 40 operates to change the pass permission state/pass non-permission state of the pass point in response to the signals from the access control device 10, more particularly, from the drive control section 104. For example, if the controller is the electronic key, the unlocked or locked state is changed in response to the signal from a movement judging section.

The wireless IC tag 20 stores identification information in advance, and is a device which is capable of wirelessly reading the identification information. While, in the embodiment, the wireless IC tag 20 was referred to as, any equipment other than the wireless IC tag 20 is applicable to the present invention as long as it can have a similar function.

[Exemplary Operation of the Access Control Device]

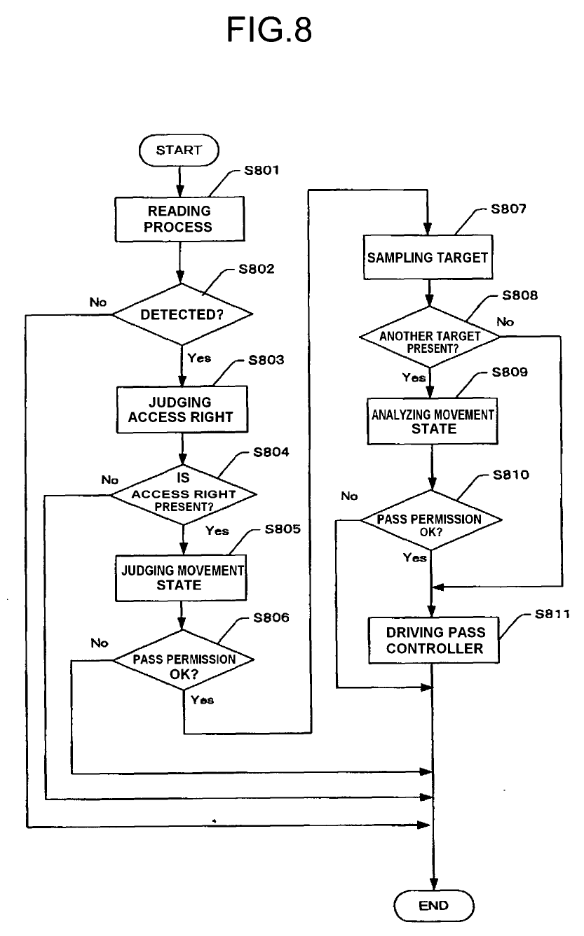

Next, an access control method, which is provided as an exemplary operation of the access control system 1 according to the embodiment, will be described with referring to the flowchart showing an exemplary operation of the access control system 1 of FIG. 8.

First, the access control system 1 executes processing of reading the wireless IC tag 20 (S801). More particularly, this system transmits a signal for reading a radio wave from the reader/writer 30, and then, detects the presence or absence of a response from the wireless IC tag 20 by means of the reader/writer 30.

If the reader/writer 30 has failed to detect the wireless IC tag 20 (S802, No), the access control system 1 terminates execution of the access control method without doing anything.

If there is a response from the wireless IC tag 20, and then, the reader/writer 30 has detected the wireless IC tag 20 (S802, Yes), the access control system 1, more particularly, the right judging section 102, receives a unique ID read from the wireless IC tag 20, and, based upon this unique ID, judges whether or not the unique ID has a pass right or an access right (S803). At this time, the reader/writer 30 passes the unique ID read from the wireless IC tag 20 to the right judging section 102 and passes to the movement analyzing section 103 the measurement result of the electric field intensity received at the time of reading the unique ID.

If the right judging section 102 judges that the unique ID fails to have an access right (S804, No), the access control system 1 terminates execution of the access control method without doing anything.

On the other hand, if the right judging section 102 judges that the unique ID has the access right (S804, Yes), the access control system 1, more particularly, the movement analyzing section 103, computes the position and movement state of the wireless IC tag 20 judged that the ID has the access right, based upon the measurement result of the electric field intensity acquired from the reader/writer 30, and then, judges the movement state, based upon the computation result (S805). For example, the movement analyzing section 103 computes data indicating that the position at time A of the wireless IC tag 20 is a coordinate (a, b) and that the movement vector is (l, m), and then, judges whether or not the pass point may be placed in a pass permission state, based upon the movement analysis result that is the computed data.

If the movement analyzing section 103 judges that the pass permission state may not be established (S806, No), for example, if the wireless IC tag 20 is moving to a site distant from the pass point, the access control system 1 terminates execution of the access control method without doing anything.

On the other hand, if the movement analyzing section 103 judges that the pass permission state may be established (S806, Yes), for example, if the wireless IC tag 20 is moving toward the pass point, the access control system 1, more particularly, the image analyzing section 101 performs target sampling, samples targets (such as objects, persons, vehicles which do not exist in imaging range in a normal state) from image data within the imaging range; and, referring to the analysis result of the movement analyzing section 103, determines which of the sampled targets corresponds to the wireless IC tag 20 read at S801 (equivalent to the wireless IC tag holder 201), or alternatively, which of them does not correspond to the wireless IC tag 20 (equivalent to the wireless IC tag non-holder 202) (S807).

If the target sampled by the image analyzing section 101 is a target corresponding to the wireless IC tag 20, i.e., is only the wireless IC tag holder 201, in other words, if the wireless IC tag non-holder 202 is not detected (S808, No), the image analyzing section 101 requests the drive control section 104 to place the pass point in the pass permission state, and, in response to this request, the drive control section 104 drives the pass controller 40 (S811).

On the other hand, if there has existed the target sampled by the image analyzing section 101 other than that corresponding to the wireless IC tag 20, i.e., if the wireless IC tag non-holder 202 has been detected (S808, Yes), the image analyzing section 101 analyzes the position and movement state of the wireless IC tag non-holder 202 (S809).

Based upon the analyzed position and movement state, the movement analyzing section 103 judges whether or not the pass permission state may be established (S810).

If the movement analyzing section 103 judges that the pass permission state may not be established (S810, No), for example, if the wireless IC tag non-holder 202 is moving to approach the pass point, or alternatively, if the non-holder stays near the pass point, the access control system 1 terminates execution of the access control method without doing anything.

On the other hand, if the movement analyzing section 103 judges that the pass permission state may be established (S810, Yes), for example, if the wireless IC tag non-holder 202 is moving to a site distant from the pass point, or alternatively, if the non-holder stays at a site distant from the pass point, the access control system 1, more particularly, the movement analyzing section 103 requests the drive control section to place the pass point in the pass permission state, and, in response to this request, the drive control section 104 drives the pass controller 40 (S811).

The access control system 1 repeatedly executes the above S801 to S811 with a predetermined timing, thereby changing an appropriate pass point to the pass permission state.

### Second Embodiment

While, in the first embodiment, it was described that the reader/writer 30 measures the intensity (electromagnetic intensity, electric field intensity) of a signal received from the wireless IC tag 20, and then, outputs the measured intensity as information, a reader/writer 30 according to the second embodiment outputs, as information, the number of successes of reading or a success rate relevant to the unique ID of the wireless IC tag 20. For example, the reader/writer 30 outputs information indicating that, as the result of performing 100 reading processes, the number of successes is “50” or the success rate is 50% for unique ID “0001” and the number of accesses is “75” or the success rate is 75% for the unique ID “0001”.

The movement analyzing section 103 of the access control device 10 in the embodiment is different from that of the first embodiment in that the position and movement state of the wireless IC tag 20 having unique ID are judged, based upon the number of success of reading or a success rate relevant to the unique ID that the reader/writer 30 outputs.

In each of the reading processes, each reader/writer 30 communicates with all of the wireless IC tags 20 existing in the communication area of such each reader/writer 30, and notifies to the movement analyzing section 103 all of the unique IDs that were successfully read as the result of communication.

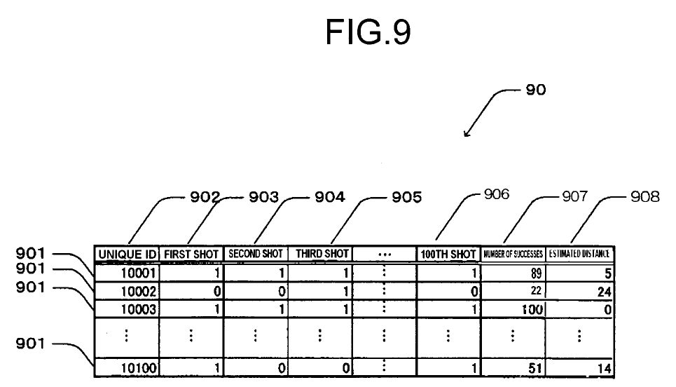

The movement analyzing section 103 has a function of storing the reading result that each reader/writer 30 notified. FIG. 9 shows an example of reading result data which the movement analyzing section 103 stores. The reading result data shown in FIG. 9 indicates an example of table-storing the reading result from one reader/writer. Such table 90 is stored in the movement analyzing section 103 on one-by-one-table basis, with respect to each reader/writer 30.

The table 90 has one record 901 by unique ID which the reader/writer 30 read. Each record 901 has: a unique ID field 901 storing a unique ID; a first-shot field 903 storing whether or not reading of the corresponding unique ID has succeeded as the result of the first reading process; a second-shot field 904 storing whether or not reading of the corresponding unique ID has succeeded as the result of the second reading process; a third-shot filed 905 storing whether or not reading of the corresponding unique ID has succeeded as the result of the third reading process, . . . (from a fourth-shot field to a 99^{th}-shot field are not shown); a 100^{th}-shot field 906 storing whether or not reading of the corresponding unique ID has succeeded as the result of the 100^{th} reading process that is a predetermined number of shots; a number-of-successes field 907 storing the number of successes of reading, from among the results of the first to 100^{th} reading processes; and an estimated-distance field 908 determined based upon the number of successes.

The unique ID that was notified from the reader/writer 30 is stored in the unique ID field 902. One unique ID is stored in one record, and thus, if ninety unique IDs have been read, for example, by one reading operation, ninety records 901 are produced in table 90.

In the first-shot field 903 to the 100^{th}-shot field 906, as the result of the reading process of these shots, information is stored which is indicative of whether or not the corresponding unique ID has been notified from the reader/writer 30. In this example, “1” indicates that the corresponding unique ID has been notified from the reader/writer 30 in the reading result of that shot, i.e., that reading of the wireless IC tag 20 having a unique ID has succeeded, and “0” indicates that the above ID has not been notified, i.e., that reading of the above tag has failed.

The number-of-successes field 907 stores the number of fields storing information indicating that the corresponding unique ID has been notified from the reader/writer 30, from the first-shot field 903 to the 100^{th}-shot field 906, i.e., the number of successes of reading the wireless IC tag 20 having the unique ID corresponding to that record 901.

The estimated-distance field 908 stores a distance which is estimated based upon the number of successes stored in the number-of-successes field 907, i.e., an estimated distance between the wireless IC tag having the unique ID corresponding to that record and this reader/writer 30. While the estimated distance is information computed by means of the movement analyzing section 103, and is defined as part of the table 90 in this example, the computed information does not always need to be so.

As set forth previously, the abovementioned table 90 is produced for each reader/writer 30 by one.

The motion analyzing section 103 computes an estimated distance between each reader/writer 30 and the wireless IC tag 20 having its own unique ID, based upon the number of successes stored in the number-of-successes field 907, and then, computes an estimated position of the wireless IC tag 20 having its own unique ID, based upon each estimated distance.

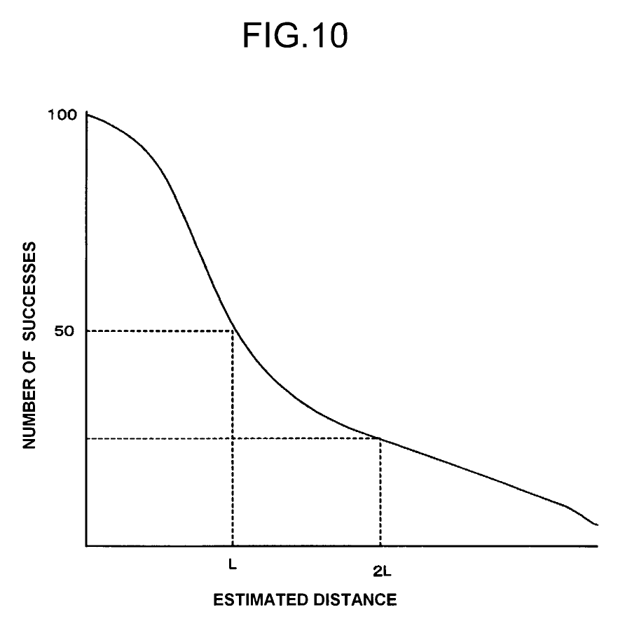

FIG. 10 shows an example of data used for the movement analyzing section 103 to compute the estimated distance from the number of successes. The data shown in the figure is a graph for uniquely defining the estimated distance in accordance with the value of the number of successes (longitudinal axis). For example, it is possible to determine that, if the number of successes is 100, the estimated distance is 0; if the number of successes is 50, the estimated distance is L; and if the number of successes is 25, the estimated distance is 2L. Although it is contemplated that such data is produced by taking statistics of the number of successes while varying a distance between the wireless IC tag 20 and the reader/writer 30, for example, such data may be produced by any other method.

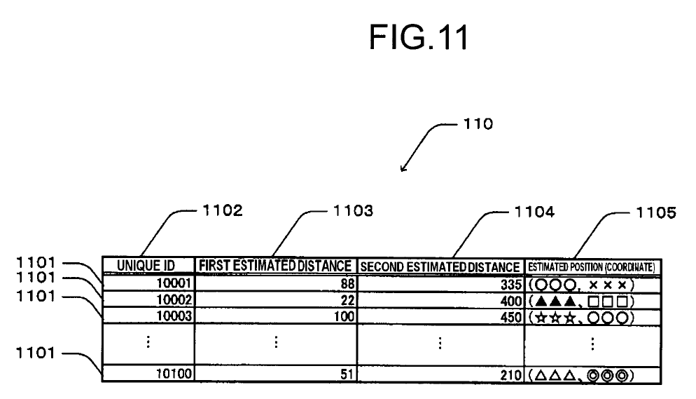

FIG. 11 shows an exemplary table storing a result of computing the estimated position of the wireless IC tag 20, based upon the estimated distance computed from the number of successes. In this example, it is presupposed that a position is specified using two different readers/writers 30 (hereinafter, discriminately referred to as a reader/writer A and a reader/writer B). This table 110 has one record 1101 for each unique ID. Each record 1101 has: a unique ID field 1102 storing a unique ID; a first estimated-distance field 1103 storing an estimated distance from the reader/writer A; a second estimated-distance field 1104 storing an estimated distance from the reader/writer B; and an estimated-position field 1105 storing an estimated position of the wireless IC tag 20 corresponding to a unique ID.

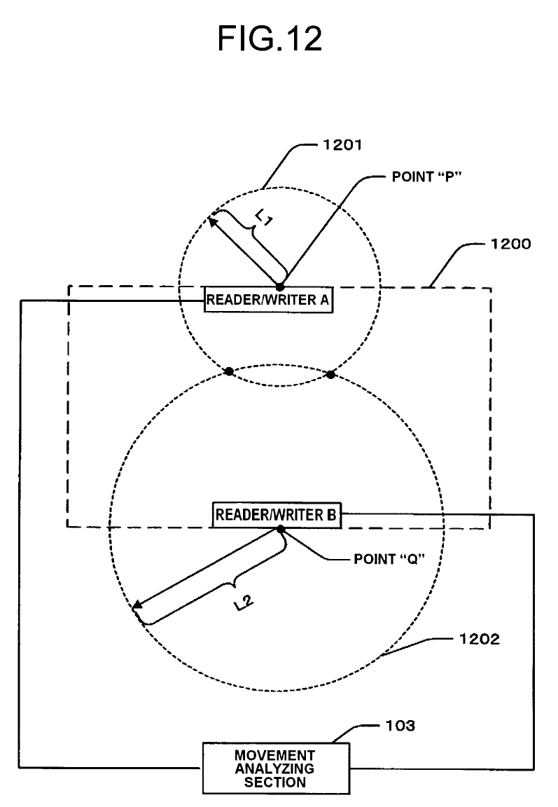

The movement analyzing section 103 calculates the estimated-position stored in an estimated-position field 1105, based upon the estimated-distances stored in the first and second estimated-distance fields 1103 and 1104. FIG. 12 is a conceptual view of a method of calculating the estimated position, based upon the estimated distances stored in the first and second estimated-distance fields 1103 and 1104. In this example, two readers/writers A and B are provided in a space (for example, an inventory). The position of the reader/writer A is defined as a point P and that of the reader/writer B is defined as a point Q.

Now, presuppose that the estimated-distance between a wireless IC tag 20 and the reader/writer A is L1 and that of the wireless IC tag 20 and the reader/writer B is L2. It is contemplated that the wireless IC tag is present on a circle 1201 of a radius L1 of which center is the point P and exists at a position meeting the coverage on a circle 1202 of a radius L2 of which center is the point P. In other words, the estimated position of the wireless IC tag 20 can be obtained by finding a cross point between the circles 1201 and 1202.

The estimated position does not always need to be coordinate information and information for specifying an area having a wideness (for example, individual partitions obtained by dividing the space into 16 sections) may be an estimated position. In the example shown in FIG. 12, two cross points exist, so that a coordinate cannot be uniquely found. In such case, an area including these two cross points may be an estimated position.

The estimated positions computed as set forth above are stored in an estimated-position field 1105 of each record 1101. By referring to this table 110, the movement analyzing section 103 is capable of computing the estimated position on a specific-ID basis, and computing the estimated position of the wireless IC tags 20 and a movement state that is based upon the estimated position.

The position and movement state are employed in judging a movement state (S805) of FIG. 8 in the same manner as that in the first embodiment, and the subsequent processes (S806 to S811) are also performed in the same manner as that in the first embodiment.

Matters other than the above are all identical to those of the first embodiment, and thus, a detailed description thereof is omitted.

[Exemplary Modifications and Others]

(1) While the foregoing embodiments described determining an estimated distance based upon the number of successes, the present invention is achieved if the estimated distance is determined based upon a success rate (the number of successes/total reading count).

(2) The abovementioned access control system 1 may further add an authentication portion for performing biometrics authentication. For example, in a state in which the holder of the wireless IC tag 20 arrives at a point immediately preceding a pass point, biometrics authentication of fingerprints, veins, faces, and irises or the like is performed, so that, only if this biometric authentication has been successfully performed, driving of the pass controller 40 at step S811 is executed. By way of such modification, it is possible to prevent a person, who has illegally acquired (has picked up or stolen) the wireless IC tag 20, from entering a control target area.

(3) An artificial-voice generating portion is further added to the abovementioned access control system so that various messages or warnings may be generated in executing the abovementioned access control method. For example, the wireless IC tag non-holder 202 stays near the pass point, and thus, if the pass controller 40 cannot be driven, a message “KEEP AWAY FROM PASS POINT IMMEDIATELY!!” may be generated by way of artificial voice or the like. Further, if the wireless IC tag holder 201 or the wireless IC tag non-holder 202 rapidly approaches a pass point, and there might be a collision, a message “DANGER!! SLOW DOWN” may be generated by means of artificial voice or the like.

The present specification is based upon Patent Application No. 2006-146550 filed on May 26, 2006, the contents of which are incorporated therein.

### INDUSTRIAL APPLICABILITY

As has been described above, an access control system and device according to the present invention serves to: control whether or not an access passing through a pass point is possible, based upon identification information read from an identification information storage medium; based upon the identification information, judge whether or not the pass point is placed in a pass permission state, based upon the presence or absence of the right of an access relevant to the identification information storage medium, the position and movement state of the identification information storage medium, and the presence or absence of a target other than that which owns the identification information storage medium, thereby preventing, if the access control system operates and a door etc., is opened, the entry of a third party due to abuse of an opportunity of the opening. Therefore, the inventive system and device has industrial applicability.

1. An access control system of reading identification information from an identification information storage medium storing the identification information which is wirelessly readable, and controlling an access passing through a pass point, based upon the read identification information, said system comprising:
a reading portion for reading the identification information and measuring a signal state at a time of reading the identification information;
an imaging portion for imaging periphery of the pass point; and
an access control device, which judges whether or not an access is possible, based upon outputs of the reading portion and imaging portion,
wherein the access control device serves to:
judge presence or absence of an access right relevant to the identification information storage medium, based upon the identification information, and compute a position and a movement state of the identification information storage medium from the signal state at the time of reading the identification information;
judge presence or absence of a target other than that which owns the identification information storage medium, from image data output by the imaging portion; and
judge whether or not the pass point is placed in a pass permission state, based upon the presence or absence of the access right, the position and movement state of the identification information storage medium, and the presence or absence of said other target.

2. The access control system according to claim 1, wherein the access control device judges the position and movement state of said other target from image data output by the imaging portion, and judges whether or not the pass point is placed in a pass permission state, based upon the position and movement state of the other target.

3. The access control system according to claim 1, wherein the reading portion measures, as the signal state, at least one of electric field intensity at the time of reading the identification information and number of successes of reading the identification information.

4. The access control system according to claim 1, wherein the access control system controls a pass on the pass point instead of an access passing the pass point; and the access control device serves to judge the presence or absence of a pass access right relevant to the identification information storage medium, based upon the identification information, and judges whether or not the pass point is placed in a pass permission state, based upon the presence or absence of the pass access right.

5. An access control device, comprising:
a right judging portion for judging presence or absence of an access right for passing through a pass point, based upon identification information read from an identification storage medium;
a movement analyzing portion for computing a distance from the identification information storage medium, based upon a signal state at a time of reading the identification information, and then, computing a position and a movement state of the identification information storage medium, based upon the computed distance; and
an image analyzing portion for analyzing image data obtained by imaging periphery of the pass point, thereby sampling a target existing in an imaging range which is an area of the periphery of the pass point and computing a position and a movement state of a target which does not correspond to the identification information storage medium, from among the sampled target,
wherein it is judged whether or not the pass point is placed in a pass permission state, based upon the presence or absence of a right of the access, the position and movement state of the identification information storage medium, and the position and movement state of the target which does not correspond to the identification information storage medium.

6. The access control device according to claim 5, wherein the movement analyzing portion computes, as the signal state, a distance from the identification information storage medium, in response to at least one of the electric field intensity at the time of reading the identification information and the number of successes of reading the identification information.

7. The access control device according to claim 5, wherein the presence or absence of passing on the pass point is judged instead of an access passing the pass point, based upon the identification information, and whether or not the pass point is placed in a pass permission state is judged based upon the presence or absence of a right of the pass.
